(19) United States
(12) Patent Application Publication
(10) Pub. No.: US 2013/0277394 A1
(43) Pub. Date: Oct. 24, 2013

(54) MOVEABLE ROLL AROUND SELF-CONTAINED ICE COOLED BEVERAGE DISPENSING APPARATUS

(71) Applicant: SCHROEDER INDUSTRIES,INC. D/B/A SCHROEDER AMERICA, San Antonio, TX (US)

(72) Inventor: William Edwards, Selma, TX (US)

(73) Assignee: Schroeder Industries, Inc. d/b/a Schroeder America, San Antonio, TX (US)

(21) Appl. No.: 13/786,515

(22) Filed: Mar. 6, 2013

Related U.S. Application Data
(60) Provisional application No. 61/625,978, filed on Apr. 18, 2012.

(51) Int. Cl. B67D 7/06; B67D 7/80; B67D 7/74

(52) U.S. Cl. CPC B67D 1/0891
USPC 222/144.5; 222/129.1; 222/146.6; 222/608

(57) ABSTRACT

A substantially self-contained moveable (roll around) ice cooled beverage dispensing apparatus, in one embodiment, disclosing onboard pressurized bag-in-box syrup concentrate, onboard carbonation and pump elements, as well as onboard cooling in a portable roll around unit, connecting up to a self-contained unit source of water, source of high pressurize CO₂ (onboard in one embodiment) and/or AC electricity. These three elements are common elements, in the sense that electricity and water are typically available at most retail store locations where dispensing is desired and CO₂ easily available in high pressure bottles, for example.

This application claims priority to and the benefit of U.S. Provisional Patent Application Ser. No. 61/625,978, filed Apr. 18, 2012.

### FIELD OF THE INVENTION

Modular, portable ice bath cooled, self-contained beverage dispensing unit.

### BACKGROUND OF THE INVENTION

Beverage dispensing apparatuses sometimes use a cold plate for cooling a beverage dispensed from a tower or from a bar gun at the removed end of a python. Dispensing devices may take a number of different configurations, but typically use an externally located source of concentrate, water, and pressurization. This is often done to minimize components at given locations within a retail establishment or to reduce bulk at any one location. For example, it is typical to run bag-in-a-box concentrates and pumps from a rack located remotely from other elements of a dispensing apparatus and to fluidly connect the remote elements to the dispensing apparatus through pressurized fluid bearing tubes. Such a setup may provide optimum conditions for retail convenient stores, for example. This would be the case when the pumps and syrup were in a back room of a retail store and the dispensing elements are up front for consumer access.

### SUMMARY OF THE INVENTION

Applicant provides a substantially self-contained moveable (roll around) ice cooled beverage dispensing apparatus.

In one embodiment, Applicant discloses onboard pressurized bag-in-box syrup concentrate, onboard carbonation and pump elements, as well as onboard cooling in a portable roll around unit. Connecting up to Applicant's self-contained unit is a source of water, source of high pressurize CO₂ (onboard in one embodiment) and/or AC electricity. These three elements are common elements, in the sense that electricity and water are typically available at most retail store locations where dispensing is desired and CO₂ easily available in high pressure bottles, for example.

### BRIEF DESCRIPTION OF THE DRAWINGS

FIG. 1 is a right-side perspective view of Applicant's roll around unit with two side walls at the top removed therefrom.

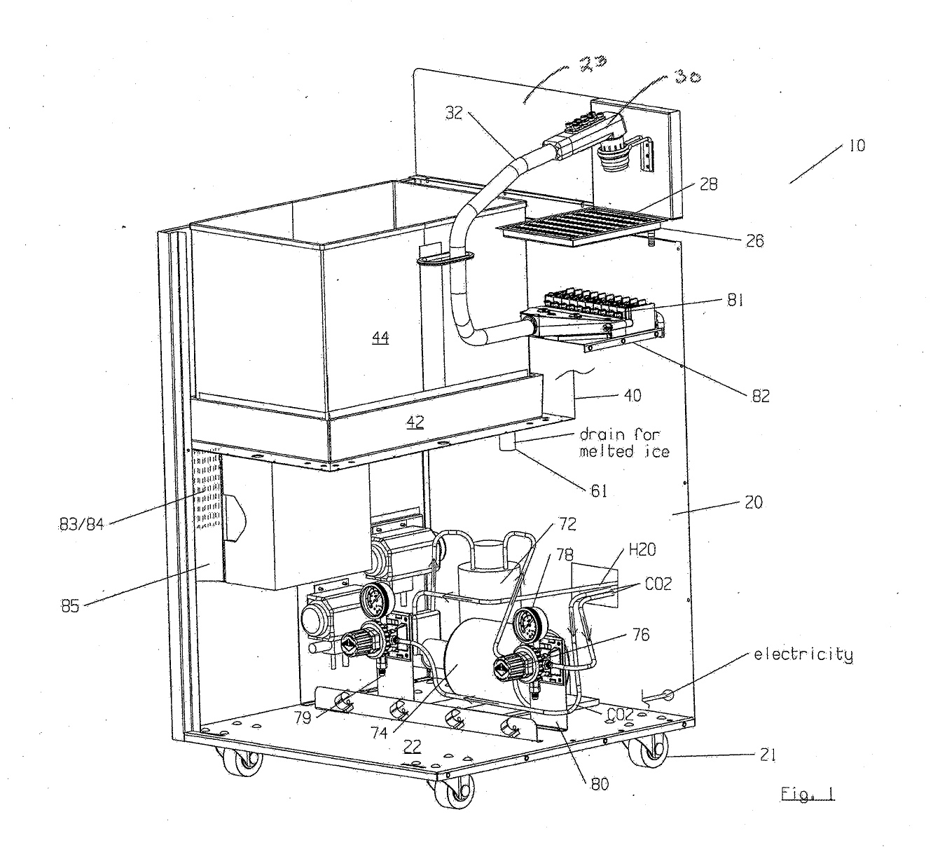

FIG. 2 is an external front left perspective view of Applicant's roll around unit with the housing intact and all walls thereon.

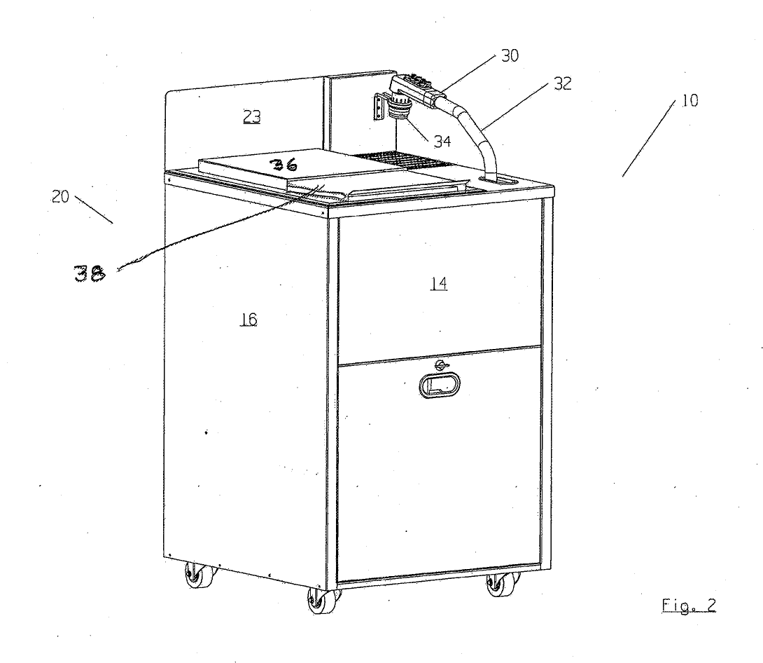

FIG. 3 is a front right upper view of Applicant's roll around unit with the front door of the housing open to show some of the elements inside.

FIG. 4 is a rear right side upper view of Applicant's roll around unit with the rear panel removed therefrom.

FIG. 4A is an embodiment in rear perspective with rear and a side panel removed.

FIG. 5 is a schematic layout of the gas (CO₂) and fluid flow circuits of Applicant's roll around unit. FIG. 5 illustration in dashed lines shows the elements typically located within the housing of the unit.

### DETAILED DESCRIPTION OF PREFERRED EMBODIMENT

Applicant's roll around bar gun unit, sometimes called roll around unit 10, is illustrated in the Figures comprising a substantially rectangular housing 12 made of stainless steel or the suitable metal, the housing typically comprising a front door or removable panel (typically removable without the use of tools) 14 and side removable panels 16/18 (typically without the use of tools), as well as a back or rear panel 20, a bottom or floor 22, and a top 24 completes Applicant's housing 12. It is seen, however, that housing 12 typically has a multiplicity of caster wheels 21 typically below the four corners defining the bottom or floor 22 and wheels typically being lockable and on casters so they can rotate, allowing the unit 10 to be pushed in any direction.

An optional backsplash 23 may extend upward from rear panel 20 above top 24. Top 24 is seen to be configured with a grill or cup rest 28 for receipt of a container (not shown) thereon, beneath which lies a drip tray 26 for accumulating dripped fluid therein. Cup rest 28 usually lies on or above an upper perimeter of drip tray 26 A bar gun 30 extends from an access port 31, which allows a python 32 to extend through top 24. Python 32 typically has bar gun 30 at the removed end thereof, which bar gun has multiple buttons and a nozzle as known in the art, which buttons can be depressed for mixing, via post-mix, a concentrate and carbonated or plain water into a container. A bar gun holding device or holster 34 is configured for receipt of the bar gun therein and may receive the bar gun when the bar gun is not in use. Holster 34 may preferably engage either top 24 or backsplash 23 and is typically placed so the nozzle is above drip tray 26 and/or cup rest 28. Top 24 of housing 12 is also configured to receive a fixed cover 36 and a sliding cover 38 thereon, at which sliding cover 38 can cover and uncover an ice bin 40. Ice bin 40 may include an insulated liner 44 with a cold plate 42 at the bottom thereof. Ice bin 40 is configured in ways known in the art to receive ice, water and/or ice water, and cold plate 42 is configured in ways known in the art with multiple fluid bearing lines passing therethrough. The cold plate will lose heat to ice and ice water in the ice bin 40, so as to cool the fluid in the lines inside the cold plate, which cooled fluid will be dispensed from bar gun 30.

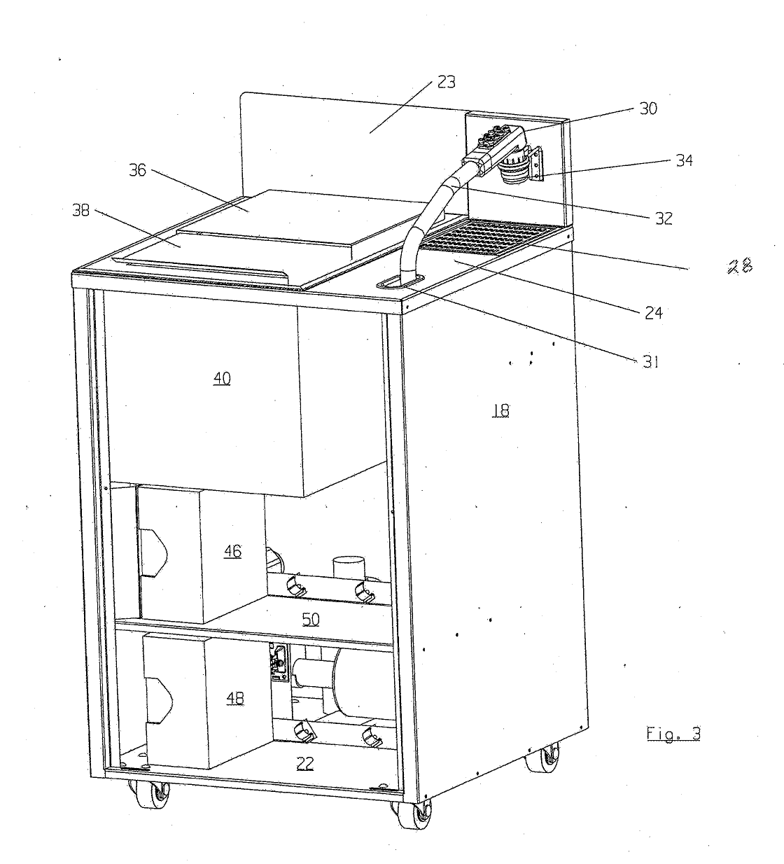

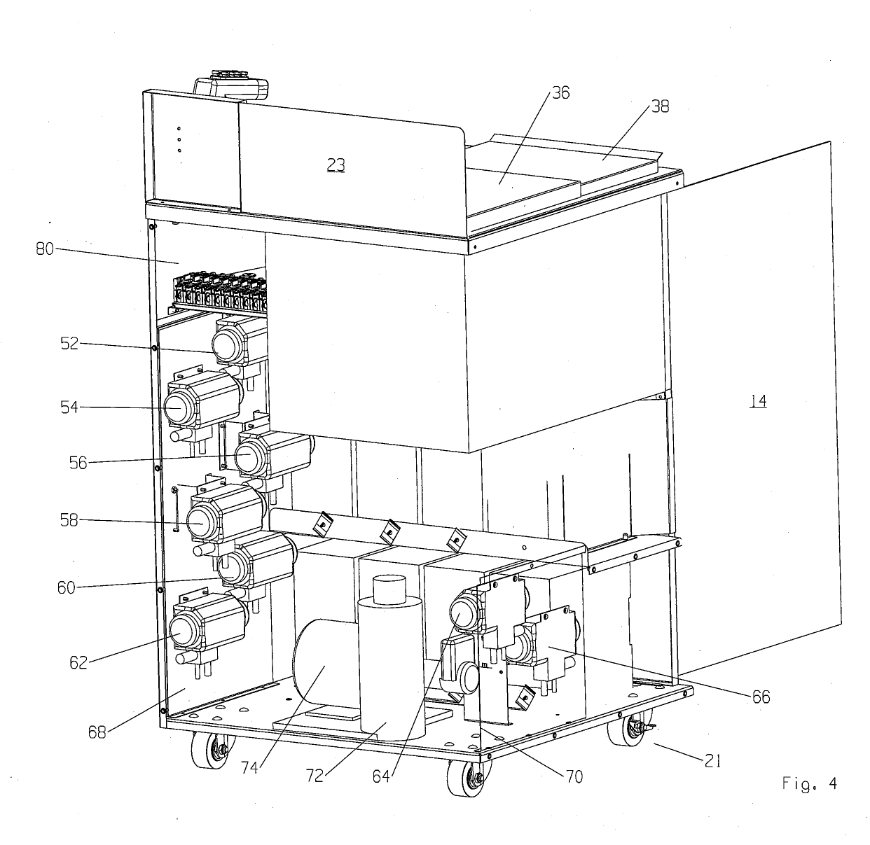

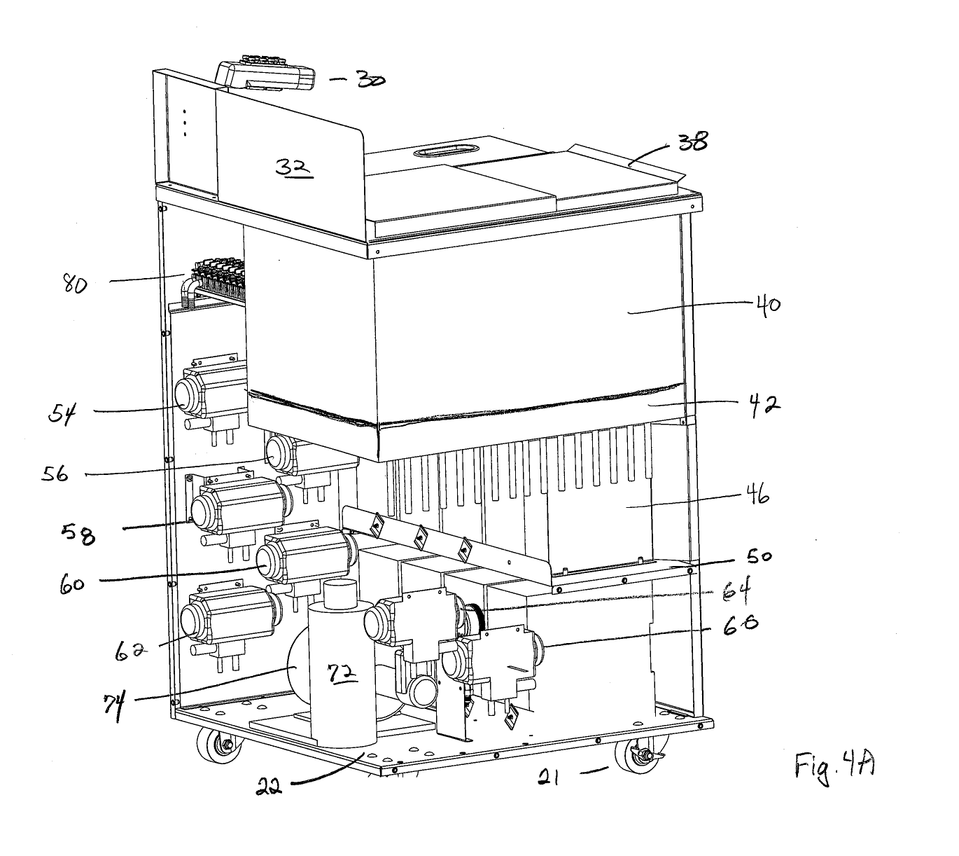

In FIG. 3, it is seen that when Applicant's door is open, floor 22 and at least one support shelf 50 provide for receipt and location of a multiplicity of, here, eight, bag-in-box (or other concentrate) containers designated 46, when resting on shelf 50 (typically four) and designated with the element 48 for resting on the upper surface of floor 22. Multiple bag-in-box or other concentrate sources engage fluid lines in ways known in the art, which lines engage the low end of the pumps, here, eight, 52/54/56/58/60/62/64/66 which pumps, such as flow jet pumps, driven by high pressure air are designed for engagement with bag-in-box to pressurize the fluid therein. Pump mounting panels 68/70 may engage either side wall and the pumps may be staggered, as seen in FIG. 4A.

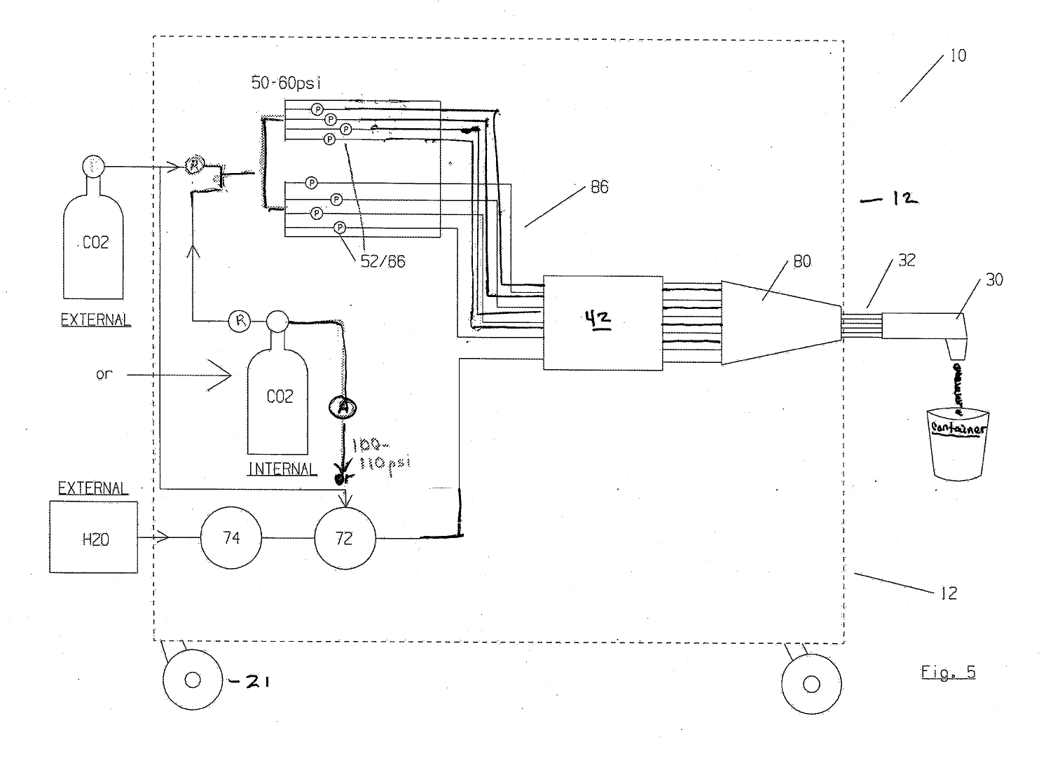

Ice bin and liner may include a drain 61, so as ice melts it may drain into, for example, an external source, such as a bucket (not shown). A carbonator 72 and carbonator motor 74 are known in the art, carbonator motor 74 for receiving a fluid, such as water from an external source, such as city water, and pressurizing it for injection into carbonator 72 in ways known in the art. Carbonator 72 also receives high pressure CO₂ gas from an external or onboard source, such as a small compressed CO₂ gas cylinder (see FIG. 5). A regulator 79 may be provided to regulate CO₂ for pumps 52 thru 66. Gauge 78 may be used with adjustable regulator 76 mounted to a mounting panel 80 for receipt of CO₂ for controlled flow of the CO₂ from an external source (see FIG. 5) or an onboard source to the carbonator 72. An onboard CO₂ container may be used.

Downstream of the carbonator, carbonated water is engaged to tubes running through cold plate 42 and then to manifold and flow control unit 80. Downstream of pumps 52/54/56/58/60/62/64/66, flexible lines will engage ports of cold plate 42 for circulating concentrate through the cold plate. Downstream of the cold plate, lines carry concentrate to the upstream side of a manifold and flow control 80 as known in the art. All fluids in manifold flow control 80 may have adjustable flow volumes as known in the art for accurate brixing in the nozzle of the bar gun during the dispensing process. Manifold flow control 80 may be, for example, Schroeder America Part No. 660-0001-30, and may be located on a support bracket 82 beneath the top 24 in a horizontal position just below a top opening cutout in which drip tray 26 rests. Therefore, drip tray 26 may be lifted out (no fasteners) from the brackets on which it rests, and the opening in which it sits will provide the user access to the vertically oriented flow control adjuster elements 81 of the manifold and flow control assembly 80. No tools (no fasteners) are typically required for this operation. Water inlines 83 and water outlines 84 go to and from the cold plate, respectively, out lines 84 taking the carbonated cold water to the upstream end of the manifold flow control 80 and line 83 from carbonator to the cold plate. Divider plate 85 is provided for keeping the lines separate and adjacent the inner surface of a side wall. Lines 86 carry bag-in-box or other concentrate from the high end of the pumps to the inlet of the cold plate. Cold plate 42 may lay generally parallel at the bottom of the ice bin and have at least an upper surface thereof in contact with the ice and ice water mix of the interior of the ice bin.

FIG. 5 is a schematic illustration of elements that may be housed within housing 12 having wheels 21 thereon, of Applicants' roll around unit 10. It is seen that the CO₂ source may be onboard attached within the interior of the housing or it may be external. There will be typically two CO₂ lines, one connecting up with the pump and bag-in-box combination, engaged in ways known in the art to use compressed gas to drive pumps 52/66 and syrup to the cold plate, then to the manifold flow control, to the bar gun. About 50 to 60 psi of regulated gas, for example, may be provided to drive the pump and bag-in-box syrup through the cold plate flow control elements python and bar gun for mixing with carbonated water, also run through the cold plate manifold flow control, python and bar gun for, typically, post-mixing flow into a container. In the alternative, instead of having CO₂ driven pumps, an electrically driven pump/bag-in-box combination may be used.

Although the invention has been described with reference to a specific embodiment, this description is not meant to be construed in a limiting sense. On the contrary, various modifications of the disclosed embodiments will become apparent to those skilled in the art upon reference to the description of the invention. It is therefore contemplated that the appended claims will cover such modifications, alternatives, and equivalents that fall within the true spirit and scope of the invention.

1. A beverage dispensing device comprising:
a housing having a top wall, a front wall, two side walls, a floor, a backsplash, and a back wall, the housing top including a closeable top opening; the housing including a housing interior having shelves therein, configured to hold a multiplicity of bag-in-box beverage concentrate sources;
a multiplicity of wheels configured to engage the housing on a support surface;
an ice bin having an opening facing the top opening of the housing, insulated side walls and a cold plate engaging a floor thereof;
a multiplicity of concentrate sources, wherein the housing is configured for receipt of the concentrate sources in the interior therein;
a beverage flow control dispensing assembly comprising a valve/manifold unit engaging the housing, a python, and a bar gun at the removed end of the python, the python capable of being at least partly spaced apart from the housing;
a multiplicity of pumps, and fluid lines configured to engage the concentrate sources, pumps, cold plate, and beverage flow control dispensing assembly,
wherein the housing is configured to locate the pumps in the interior thereof;
a pump/carbonator and lines configured to engage the cold plate and valve/manifold unit;
wherein the housing is configured to locate the carbonator therein;
a water circuit, configured to engage the pump/carbonator.

2. The beverage dispensing device of claim 1, wherein the housing is substantially rectangular and made of stainless steel.

3. The beverage dispensing device of claim 1, wherein the backsplash includes a bar gun engaging member adapted to hold the bar gun over a cap rest grill member.

4. The beverage dispensing device of claim 1, wherein the bar gun includes a post-mix nozzle.

5. The beverage dispensing device of claim 1, wherein the housing includes a shelf for receiving the concentrates thereon and wherein the concentrates are bag-in-box concentrates.

6. A beverage dispensing device comprising:
a housing having a top wall, a front wall, two side walls, a floor, a backsplash, and a back wall, the housing top including a closeable top opening; the housing including a housing interior having shelves therein, configured to hold a multiplicity of bag-in-box beverage concentrate sources;
a multiplicity of wheels configured to engage the housing on a support surface;
an ice bin having an opening facing the top opening of the housing, insulated side walls and a cold plate engaging a floor thereof;
a multiplicity of concentrate sources, wherein the housing is configured for receipt of the concentrate sources in the interior therein;
a beverage flow control dispensing assembly comprising a valve/manifold unit engaging the housing, a python, and a bar gun at the removed end of the python, the python capable of being at least partly spaced apart from the housing;
a multiplicity of pumps, and fluid lines configured to engage the concentrate sources, pumps, cold plate, and beverage flow control dispensing assembly,
wherein the housing is configured to locate the pumps in the interior thereof;
a pump/carbonator and lines configured to engage the cold plate and valve/manifold unit; and
wherein the housing is configured to locate the carbonator therein;
a water circuit, configured to engage the pump/carbonator;
wherein the housing is substantially rectangular and made of stainless steel;
wherein the backsplash includes a bar gun engaging member adapted to hold the bar gun over a cap rest grill member;
wherein the bar gun includes a post-mix nozzle;
wherein the housing includes a shelf for receiving the concentrates thereon; and
wherein the concentrates are bag-in-box concentrates.
